(19) United States
(12) Patent Application Publication
(10) Pub. No.: US 2002/0122964 A1
(43) Pub. Date: Sep. 5, 2002

(54) Method and apparatus for determining an alcohol concentration in the electrolyte of fuel cells

(76) Inventor: Walter Preidel, Erlangen (DE)

Correspondence Address: LERNER AND GREENBERG, P.A., Post Office Box 2480, Hollywood, FL, 33022-2480, US

(21) Appl. No.: 10/105,841

(22) Filed: Mar. 25, 2002

Related U.S. Application Data
(63) Continuation of application No. PCT/DE00/03145, filed on Sep. 11, 2000.

(30) Foreign Application Priority Data
Sep. 24, 1999 (DE) 199 45 929.0

(51) Int. Cl. H01M 8/04

(52) U.S. Cl. 429/13; 429/25; 204/422; 429/22; 429/23

(57) ABSTRACT

In a method for determining the alcohol concentration in the alcohol/water mixture of fuel cells that are operated with the mixture, in particular direct methanol fuel cells, the measured variable being volume-dependent, the carbon dioxide which is formed during operation of the fuel cells is dissolved in the alcohol/water mixture by increasing the pressure acting on the mixture.

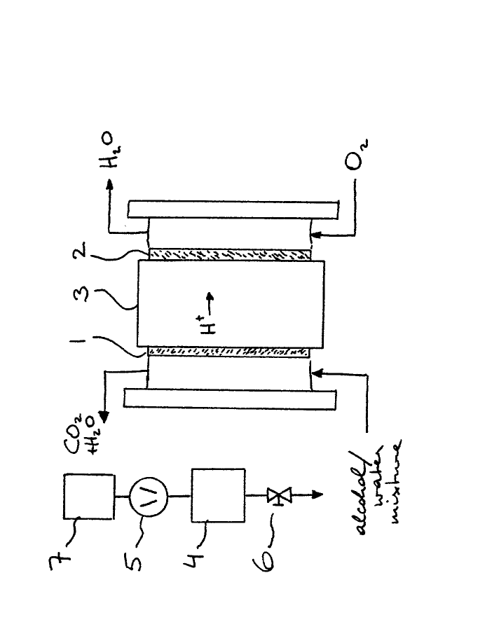

### CROSS-REFERENCE TO RELATED APPLICATION

This application is a continuation of copending International Application No. PCT/DE00/03145, filed Sep. 11, 2000, which designated the United States.

### BACKGROUND OF THE INVENTION

Field of the Invention

The invention lies in the fuel cell technology field. More specifically, the invention relates to a method for determining the alcohol concentration in the alcohol/water mixture of fuel cells which are operated with the mixture, in particular direct methanol fuel cells, whereby the measured variable is volume-dependent. The invention also relates to an apparatus for carrying out this method.

To maintain the optimum operating parameters in fuel cells which are operated with liquid fuels, it is necessary to control the fuel concentration. For this purpose, the current concentration has to be determined.

Commonly assigned U.S. Pat. No. 5,624,538 (European patent application EP 0 684 469 A1) discloses a measuring unit for determining the concentration of low-molecular weight alcohols, such as methanol, in water or acids. That measuring unit has a porous anode for the electrochemical oxidation of alcohol, a cathode for the electrochemical reduction of oxygen, an ion-conducting membrane arranged between the anode and cathode and a diffusion-limiting membrane which is arranged on that side of the anode that is remote from the ion-conducting membrane. The measuring unit which, so to speak, represents a fuel cell is, for example, arranged in the fuel line and is held at a defined cell voltage by potentiostatic means. Depending on the alcohol concentration, a current flows through this fuel cell, and the concentration can be worked out—by means of a calibration curve—from the level of this current. A procedure of this nature is relatively complex, since current and voltage have to be measured or monitored.

In so-called direct methanol fuel cells (DMFCs), the fuel methanol undergoes direct electrochemical oxidation, i.e. is reacted without the intermediate step of a reforming operation (cf. in this respect, for example, M. Waidhas in K. Ledjeff (Ed.) “Brennstoffzellen: Entwicklung, Technologie, Anwendung” [Fuel Cells: Development, Technology, Applications], C. F. Müller Verlag GmbH, Heidelberg 1995, pages 137-156). To achieve the optimum operating point in a DMFC, it is necessary to operate with dilute fuel in excess. To avoid producing large amounts of waste, it is imperative, on account of the fact that operation is in excess, for the fuel to be circulated and the required concentration to be set by metering in concentrated fuel. For this purpose, in each case the current fuel concentration then has to be measured.

During operation of direct methanol fuel cells, by way of example carbon dioxide, in the form of gas bubbles, is formed in the working layer of the anode, as a result of oxidation of the methanol. These gas bubbles may impair the measurement of the methanol concentration in the anode circuit if a measured variable which is dependent on the volume of the substance to be measured is used. This is the case, for example, when measuring the nuclear magnetic resonance.

Commonly assigned, copending application 10/078,123 proposes measuring, as the measured variable, the capacitance of a capacitor using the fuel/electrolyte mixture, for example an alcohol/water mixture, as dielectric to determine the dielectric constant of the mixture therefrom and then to determine the fuel concentration. As soon as gas bubbles are formed in or transported through the measurement cell or measurement assembly, the measurement effect in the ratio of liquid space to gas space is changed. Since the anode liquid is virtually saturated with carbon dioxide, it is also very easy for gas bubbles to form at the surfaces, and these bubbles can distort the measurement signal. This problem also cannot be solved by a bubble catcher upstream of the measurement cell.

Furthermore, U.S. Pat. No. 5,134,381 (European application EP 0 411 204 A1) describes a method for establishing the alcohol content and/or the calorific value of fuels, wherein, by measuring electrically measurable variables in a measurement cell containing the fuel, to evaluate in particular the dielectric constant as a characteristic variable of the alcohol content or of the calorific value. A measurement capacitor, wherein the capacitance is established by circuitry and/or calculation means independently of the influence of the conductivity of the fuel, is used for this purpose. When measuring fuel, there is no volume dependency of the measured variable, nor is there any risk of gas bubbles being formed.

### SUMMARY OF THE INVENTION

It is accordingly an object of the invention to provide a method of determining an alcohol concentration in the electrolyte of fuel cells, which overcomes the above-mentioned disadvantages of the heretofore-known devices and methods of this general type and which enables the determination of the alcohol concentration in the alcohol/water mixture of fuel cells which are operated with this mixture in such a manner that there can be no disruption from gas bubbles.

With the foregoing and other objects in view there is provided, in accordance with the invention, a method for determining an alcohol concentration in an alcohol/water mixture of a fuel cell operated with the alcohol/water mixture, in particular a direct methanol fuel cell, the method which comprises:

measuring a volume-dependent measured variable in the alcohol/water mixture;

increasing a pressure acting on the alcohol/water mixture to dissolve carbon dioxide being formed during an operation of the fuel cell in the mixture; and

measuring the volume-dependent measured variable with the carbon dioxide dissolved in the alcohol/water mixture, and determining the alcohol concentration therefrom.

With the above and other objects in view there is also provided, in accordance with the invention, an apparatus for determining an alcohol concentration in an alcohol/water mixture of a fuel cell operated therewith, comprising:

a line for conducting the alcohol/water mixture for operating the fuel cell;

a measurement cell arranged in said line for the alcohol/water mixture;

a delivery pump for the mixture which is arranged upstream of the measurement cell, and a pressure relief valve which is arranged downstream of the measurement cell, the arrangement of delivery pump and pressure relief valve being used to set a defined increase in pressure in the measurement cell.

In accordance with an added feature of the invention, a bubble catcher is arranged upstream of the delivery pump. In a further, concomitant feature of the invention, the measurement cell, the delivery pump, and the pressure relief valve are arranged in a bypass to the line for the alcohol/water mixture.

In the method according to the invention, increasing the pressure acting on the alcohol/water mixture leads to specifically carbon dioxide which is formed during operation of the fuel cells being dissolved in the mixture. In this way, the volume-dependent measured variable with carbon dioxide dissolved in the alcohol/water mixture can be determined, and a correct concentration for the alcohol can be determined therefrom. In this measurement method, the alcohol is in particular methanol, ethanol, propanol or glycol.

The invention therefore solves the problem associated with gas bubbles or with the formation of gas bubbles, for fuel cells with an anode and a cathode, by increasing the pressure acting on the anode liquid. Specifically, if the anode liquid is transported against an excess pressure, the carbon dioxide which is formed during operation of the fuel cells as a result of oxidation of the alcohol is dissolved—given a sufficiently high pressure difference—in the liquid, so that there are no gas bubbles formed at the surface.

The increase in pressure preferably amounts to 0.5 to 1.5·10⁵ Pa (0.5 to 1.5 bar). Even with a pressure rise in this range, gas bubbles are no longer observed, and moreover there are no bubbles formed. Consequently, the measurements for determining the alcohol concentration can be carried out without interference.

In the method according to the invention, the dielectric constant of the alcohol/water mixture can advantageously be determined as the measured variable. In this case, the capacitance is measured continuously in a measurement cell through which the alcohol/water mixture is flowing. The capacitance measurement generally takes place in the frequency range between 1 kHz and 100 MHz, preferably between 100 kHz and 10 MHz. If necessary, the temperature dependency of the capacitance is corrected by means of a temperature measurement. The measured capacitance is a direct measure of the dielectric constant and therefore the concentration of the alcohol. This is because the dielectric constant of the mixture varies in direct proportion to the mixing ratio of the constituents of the mixture.

Other features which are considered as characteristic for the invention are set forth in the appended claims.

Although the invention is illustrated and described herein as embodied in a determination of the alcohol concentration in the electrolyte of fuel cells, it is nevertheless not intended to be limited to the details explained herein, since various modifications and structural changes may be made therein without departing from the spirit of the invention and within the scope and range of equivalents of the claims.

### BRIEF DESCRIPTION OF THE DRAWING

The FIGURE is a highly schematic illustration of a DMFC with a measurement apparatus according to the invention.

### DESCRIPTION OF A PREFERRED EMBODIMENT

Referring now to the sole FIGURE of the drawing in detail, there is shown a direct methanol fuel cell DMFC with an anode 1, a cathode 2, and a membrane 3 for the hydrogen migration. An alcohol/water mixture CH₃OH+H₂O forms the fuel at the anode 1 and the reaction at the anode leads to the formation of carbon dioxide CO₂. To the left of the anode side of the fuel cell installation, there is illustrated a bypass line in which there is provided an apparatus for carrying out the method according to the invention. A measurement cell 4 or measurement configuration is arranged in a line for the alcohol/water mixture. In this line, which in particular is the delivery line for the alcohol/water mixture, there is also provided a pump 5 for delivering liquid arranged upstream of the measurement cell 4, in the feed direction. A pressure relief valve 6 follows downstream of the measurement cell 4 in this line. The configuration of the delivery pump 5 and of the pressure relief valve 6 is in this case used to set the increase in pressure.

Advantageously, a bubble catcher 7 may additionally be arranged in the delivery line, upstream of the pump. This makes it possible to remove gas bubbles when the quantity of gas in the liquid is too high or when the gas—on account of elevated temperature—is no longer completely soluble in the liquid.

The determination of the alcohol concentration does not have to be carried out directly in the delivery line for the alcohol/water mixture, but rather may also take place in a bypass to the delivery line. In this case, for this purpose the measurement cell 4, the delivery pump 5, and the pressure relief valve 6 are arranged in the bypass. In this case, it is also possible to prevent the formation of an excessively high number of bubbles by way of a suitable arrangement of the suction tube in the reservoir for the anode liquid, i.e. the alcohol/water mixture.

I claim:

1. A method for determining an alcohol concentration in an alcohol/water mixture of a fuel cell operated with the alcohol/water mixture, the method which comprises:
measuring a volume-dependent measured variable in the alcohol/water mixture;
increasing a pressure acting on the alcohol/water mixture to dissolve carbon dioxide being formed during an operation of the fuel cell in the mixture; and
measuring the volume-dependent measured variable with the carbon dioxide dissolved in the alcohol/water mixture, and determining the alcohol concentration therefrom.

2. The method according to claim 1, which comprises operating the fuel cell as a direct methanol fuel cell.

3. The method according to claim 1, which comprises increasing the pressure by between 0.5 and 1.5·10⁵ Pa.

4. The method according to claim 1, which comprises determining a dielectric constant of the mixture as the measured variable.

5. An apparatus for determining an alcohol concentration in an alcohol/water mixture of a fuel cell operated therewith, comprising:
a line for conducting the alcohol/water mixture for operating the fuel cell;
a measurement cell arranged in said line for the alcohol/water mixture;
a delivery pump for the mixture arranged in said line upstream of said measurement cell, and a pressure relief valve downstream of said measurement cell in a flow direction, said delivery pump and said pressure relief valve setting a defined increase in pressure in said measurement cell.

6. The apparatus according to claim 5, wherein a bubble catcher is disposed upstream of said delivery pump in the flow direction.

7. The apparatus according to claim 5, wherein said measurement cell, said delivery pump, and said pressure relief valve are arranged in a bypass to said line for conducting the alcohol/water mixture.
